(19) United States
(12) Patent Application Publication
(10) Pub. No.: US 2009/0034105 A1
(43) Pub. Date: Feb. 5, 2009

(54) COLOR WHEEL

(75) Inventor: YU-LUN HO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/946,346

(22) Filed: Nov. 28, 2007

(30) Foreign Application Priority Data
Jul. 31, 2007 (CN) 200710201224.9

(51) Int. Cl. G02B 7/00

(52) U.S. Cl. 359/892; 359/896

(57) ABSTRACT

An exemplary color wheel includes a carrier, a color filter, a fastening plate, and a heat dissipating unit. The carrier includes a spindle extending outwardly therefrom. The fastening plate includes a first side and a second side opposite to the first side. The second side is sleeved around the spindle. The color filter is sandwiched between the fastening plate and the carrier, and sleeved around the spindle. The heat dissipating unit engages with the first side of the fastening plate for dissipating heat from the color wheel.

### BACKGROUND

1. Technical Field

The present invention relates to color wheels and, particularly, to a color wheel which can withstand high heat during rotation.

2. Description of Related Art

A color wheel for an optical device, such as a projection device, includes a color filter which is rotated at high speed by a motor for the separation of colors from a white light passing therethrough. The separated colors are then processed by another optical element of the projection device to produce a full color image.

Generally, a conventional color wheel comprises a carrier, a color filter, and a fastening cover. The carrier comprises a spindle extending outwardly therefrom. The color filter and the fastening cover are sleeved around the spindle by adhesive. The fastening cover strengthens the fixing force between the color filter and the carrier.

In operation, the color wheel absorbs energy from the light passing therethrough and becomes hot. The longer the color wheel works, the hotter the color wheel becomes, and the faster the temperature of the color wheel rises. High temperatures can degrade the bonding properties of the adhesive between the color filter and the carrier. The color filter may shift, crack, or even separate from the carrier, particularly during high-speed rotation of the color wheel.

What is needed, therefore, is a color wheel which can withstand high heat during rotation.

### SUMMARY

In accordance with a present embodiment, a color wheel includes a carrier, a color filter, a fastening plate, and a heat dissipating unit. The carrier includes a spindle extending outwardly therefrom. The fastening plate includes a first side and a second side opposite to the first side. The second side is sleeved around the spindle. The color filter is sandwiched between the fastening plate and the carrier, and sleeved around the spindle. The heat dissipating unit engages with the first side of the fastening plate for dissipating heat from the color wheel.

Other advantages and novel features will be drawn from the following detailed description of at least one preferred embodiment, when considered in conjunction with the attached drawings.

### BRIEF DESCRIPTION OF THE DRAWINGS

Many aspects of the present color wheel can be better understood with reference to the following drawings. The components in the drawings are not necessarily drawn to scale, the emphasis instead being placed upon clearly illustrating the principles of the present camera module. Moreover, in the drawings, like reference numerals designate corresponding parts throughout the several views.

FIG. 1 is a schematic, cross-sectional view of a color wheel, according to a first present embodiment.

FIG. 2 is a side plan view of a heat dissipating unit capable of being used in the color wheel of FIG. 1.

FIG. 3 is a side plan view of another heat dissipating unit capable of being used in the color wheel of FIG. 1.

FIG. 4 is a schematic, cross-sectional view of a color wheel, according to a second present embodiment.

FIG. 5 is a schematic, cross-sectional view of a color wheel, according to a third present embodiment.

### DETAILED DESCRIPTION OF THE PREFERRED EMBODIMENTS

Embodiments of the present color wheel will now be described in detail below and with reference to the drawings.

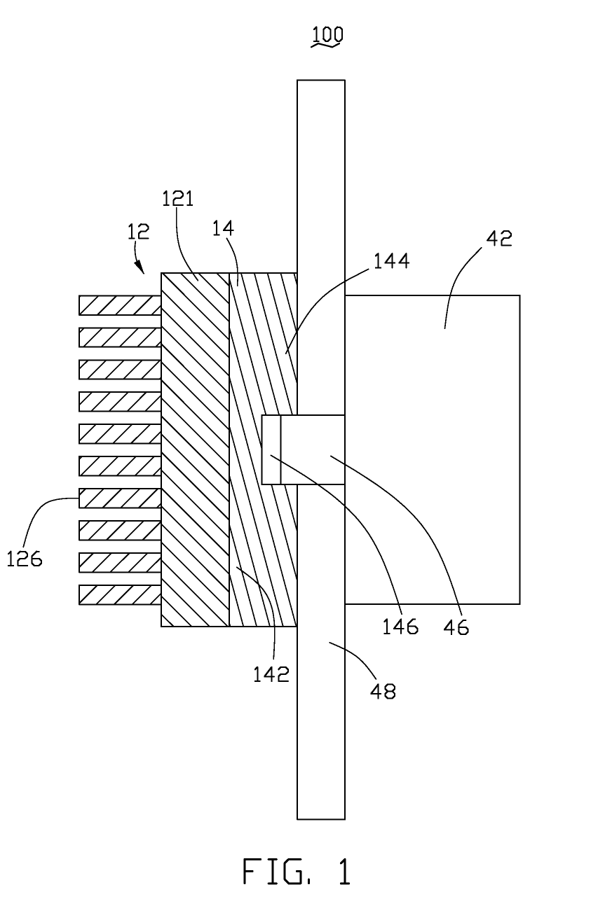

Referring to FIG. 1, a color wheel 100 in accordance with a first present embodiment comprises a carrier 42, a color filter 48, a fastening plate 14, and a heat dissipating unit 12. The fastening plate 14 and the heat dissipating unit 12 are made of metallic materials, or heat conductive polymeric materials.

The carrier 42 comprises a spindle 46 extending outwardly therefrom. The color filter 48 is sleeved around the spindle 46 and fixed to the carrier 42 by adhesive. The fastening plate 14 comprises a first side 142 where the heat dissipating unit 12 is positioned, and a second side 144 opposite to the first side 142. The second side 144 of the fastening plate 14 defines a hole 146 therein; thus, the second side 144 can also be sleeved around the spindle 46 by engaging the spindle 46 in the hole 146. The fastening plate 14 and the carrier 42 sandwich the color filter 48 therebetween.

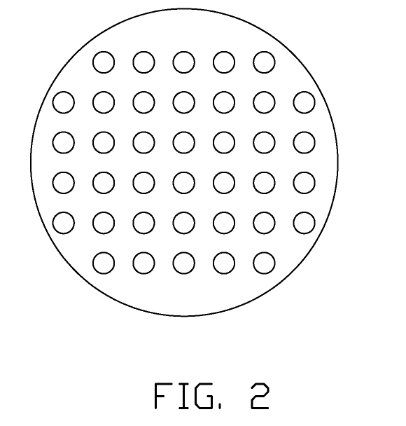

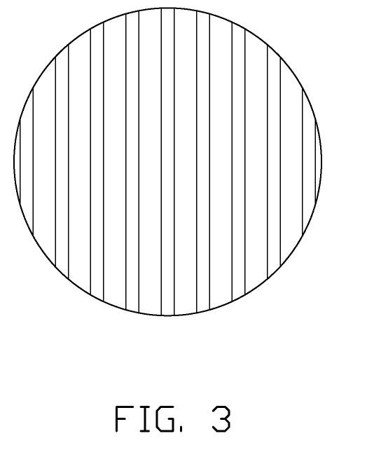

The heat dissipating unit 12 comprises a base 121 attached to the first side 142 of the fastening plate 14 for absorbing heat from the fastening plate 14, and a plurality of fins 126 extending from the base 121 for dissipating heat thereon. The fins 126 are opposite to the fastening plate 14 and may be slats or posts extending from the base as shown in FIGS. 2-3.

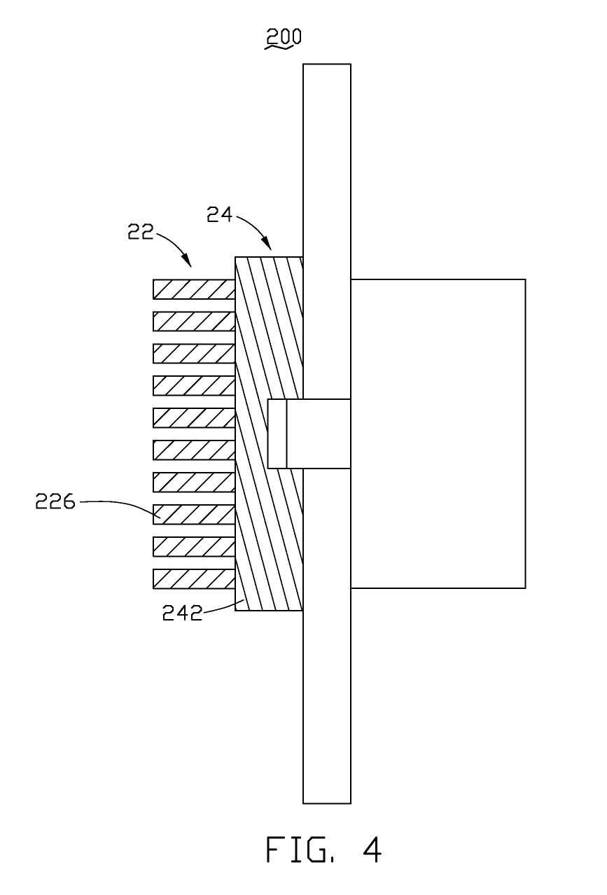

Referring to FIG. 4, a color wheel 200 in accordance with a second present embodiment is similar to the color wheel 100. However, a heat dissipating unit 22 comprises a plurality of fins 226 which directly extend from a first side 242 of a fastening plate 24. Other features of the color wheel 200 of the second embodiment can be referenced from a description of the color wheel 100 of the first embodiment.

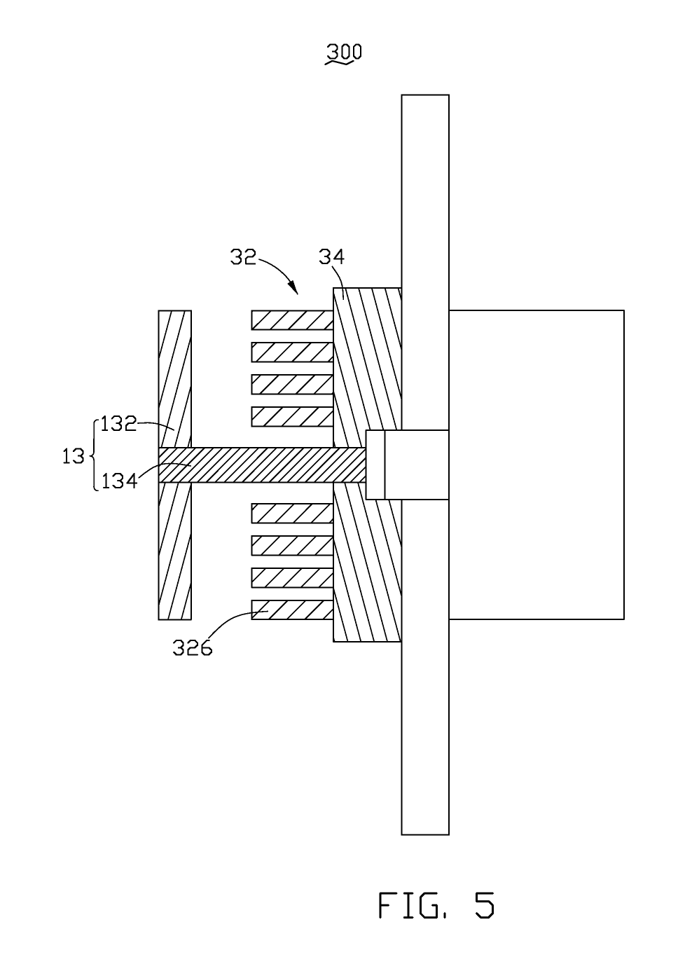

Referring to FIG. 5, a color wheel 300 in accordance with a third present embodiment is illustrated. In the color wheel 300 of the embodiment, an additional heat dissipating unit 13 is employed. The additional heat dissipating unit 13 comprises a heat dissipating portion 132 away from a fastening plate 34, and a heat transferring portion 134 engaging in the fastening plate 34 to transfer heat from the fastening plate 34 to the heat dissipating portion 132. The heat dissipating portion 132 is perpendicular to and separate from fins 326. In the third embodiment, a heat dissipating unit 32 provides an access for the heat transferring portion 134 to the fastening plate 34 by sacrificing some central fins 326 thereof. Other features of the color wheel 300 of the third embodiment can be referenced from a description of the color wheel 200 of the second embodiment.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A color wheel comprising:
a carrier comprising a spindle extending outwardly therefrom;
a fastening plate comprising a first side and a second side opposite to the first side, the second side being sleeved around the spindle;
a color filter sandwiched between the fastening plate and the carrier, and sleeved around the spindle; and
a heat dissipating unit engaging with the first side of the fastening plate for dissipating heat from the color wheel.

2. The color wheel as claimed in claim 1, wherein the heat dissipating unit comprises a base attached to the first side of the fastening plate for absorbing heat from the fastening plate, and a plurality of fins extending from the base for dissipating heat thereon.

3. The color wheel as claimed in claim 2, wherein the fins are opposite to the fastening plate.

4. The color wheel as claimed in claim 2, wherein the fins are slats extending from the base.

5. The color wheel as claimed in claim 2, wherein the fins are posts extending from the base.

6. The color wheel as claimed in claim 1, wherein the heat dissipating unit comprises a plurality of fins directly extending from the first side of the fastening plate.

7. The color wheel as claimed in claim 6, wherein the heat dissipating unit sacrifices central fins to provide an access for an additional heat dissipating unit to the fastening plate.

8. The color wheel as claimed in claim 7, wherein the additional heat dissipating unit comprises a heat dissipation portion separate from the fins and a heat transferring portion engaging in the fastening plate to transfer heat from the fastening plate to the heat dissipating portion.

9. The color wheel as claimed in claim 1, wherein the fastening plate and the heat dissipating unit are made of metallic materials, or heat-conductive polymeric materials.

10. The color wheel as claimed in claim 1, further comprising an additional heat dissipating unit having a heat dissipating portion away from the fastening plate and a heat transferring portion engaging in the fastening plate to transfer heat from the fastening plate to the heat dissipating portion.
